(19) United States
(12) Patent Application Publication
(10) Pub. No.: US 2011/0101817 A1
(43) Pub. Date: May 5, 2011

(54) VARIABLE GEOMETRY ELECTRIC MACHINE

(75) Inventors: Lei Hao, Troy, MI (US); Chandra S. Namuduri, Troy, MI (US)

(73) Assignee: GM GLOBAL TECHNOLOGY OPERATIONS, INC., DETROIT, MI (US)

(21) Appl. No.: 12/613,431

(22) Filed: Nov. 5, 2009

(51) Int. Cl. H02K 1/12

(52) U.S. Cl. 310/216.074

(57) ABSTRACT

A variable geometry electric machine that includes a moveable magnetic member that varies the flux path between a rotor and a stator of the machine depending on the machine speed to control the flux between the rotor and the stator. As the speed of the machine increases, the magnetic member is selectively withdrawn in an axial direction from between the rotor and the stator so that at higher machine speeds, the back EMF of the machine is reduced so that the speed of the machine can be increased. The magnetic member includes spaced apart magnetic strips mounted to a non-magnetic hub. In one embodiment, the magnetic strips are positioned within an air gap between the rotor and the stator and against ends of teeth of the stator, where stator coils are positioned between the teeth. In another embodiment, the magnetic strips are positioned within the teeth of the stator.

### BACKGROUND OF THE INVENTION

1. Field of the Invention

This invention relates generally to a variable geometry electric machine and, more particularly, to a permanent magnet electric machine that employs a magnetic member positioned within an air gap between a rotor and a stator of the machine, where the magnetic member is movable in an axial direction to change the flux link between the rotor and the stator to provide high torque at low speeds and reduce the back EMF at high speeds of the machine.

2. Discussion of the Related Art

An electric machine having a wide speed range is essential for automotive propulsion systems, such as for hybrid vehicles, electric vehicles, fuel cell vehicles, etc., and for power generation applications. In order to maximize the torque/ampere ratio, the electric machine is typically designed to have as high of an induced voltage-to-speed ratio as possible. However, because the induced voltage is proportional, especially as the speed of the machine increases, the back electro-motive force (EMF) generated by the machine also increases as the machine speed increases until it reaches the DC bus voltage, generally battery voltage, which results in a loss of conductivity available to drive the current in the motor that acts to limit the speed of the machine.

In order to overcome this problem, it has been proposed in the art to increase the speed of the machine by injecting a demagnetization current into the machine stator, referred to in the art as flux weakening, which reduces the back EMF of the machine so that the speed of the machine can be increased. However, injecting current into the machine magnet causes a high copper loss in the stator coils, and therefore high losses in the machine. Thus, flux weakening reduces the machine efficiency and power factor and increases the machine inverter current requirements. Alternatively, it would otherwise be necessary to increase the size of the electric machine to get the desired speed.

### SUMMARY OF THE INVENTION

In accordance with the teachings of the present invention, a variable geometry electric machine is disclosed that includes a moveable magnetic member that varies the geometry of the flux path between a rotor and a stator of the machine depending on the machine speed to control the flux linkage between the rotor and the stator. As the speed of the machine increases, the magnetic member is selectively withdrawn in an axial direction from between the rotor and the stator so that at higher machine speeds, the back EMF of the machine is reduced so that the speed of the machine can be further increased. The magnetic member includes a plurality of spaced apart magnetic strips mounted to a non-magnetic hub. In one embodiment, the magnetic strips are positioned within an air gap between the rotor and the stator and against ends of teeth of the stator, where stator coils are positioned between the teeth. In another embodiment, the magnetic strips are positioned within the teeth of the stator.

Additional features of the present invention will become apparent from the following description and appended claims, taken in conjunction with the accompanying drawings.

### BRIEF DESCRIPTION OF THE DRAWINGS

FIG. 1 is a cross-sectional view of a conventional electric machine;

FIG. 2 is a quarter section view of the electric machine shown in FIG. 1 and showing a flux path;

FIG. 3 is a cross-sectional view of an electric machine having a controllable magnetic member positioned within an air gap between the stator and the rotor of the machine;

FIG. 4 is a cut-away lengthwise cross-sectional view of the electric machine shown in FIG. 2 with the magnetic member in a position that partially links the main flux of the machine;

FIG. 5 is a cut-away lengthwise cross-sectional view of the electric machine shown in FIG. 2 with the magnetic member in a fully removed position so that the magnetic member does not link the main flux of the machine;

FIG. 6 is a graph with the percentage that the magnetic member is moved out of the machine on the horizontal axis and normal back EMF on the vertical axis;

FIG. 7 is a graph with the thickness of the magnetic strips of the conductive member of the machine shown in FIG. 3 on the horizontal axis, load loss in watts of the machine on the left vertical axis and back EMF in volts of the machine on the right EMF axis;

FIG. 8 is a cross-sectional view of an electric machine having a controllable magnetic member positioned within teeth of the stator of the machine;

FIG. 9 is a semi-spherical cross-sectional view of an electric machine including an outer rotor;

FIG. 10 is a cross-sectional view of a surface mount permanent magnet machine;

FIG. 11 is a cross-sectional view of an interior permanent magnet machine;

FIG. 12 is a cross-sectional view of a V-shaped stator for a permanent magnet machine; and

FIG. 13 is a cross-sectional view of a multilayer stator for a permanent magnet machine.

### DETAILED DESCRIPTION OF THE EMBODIMENTS

The following discussion of the embodiments of the invention directed to a variable geometry electric machine that includes a moveable magnetic member that links the main flux of the machine and is movable to reduce the flux as the speed of the machine increases to reduce the back EMF is merely exemplary in nature, and is in no way intended to limit the invention or its applications or uses.

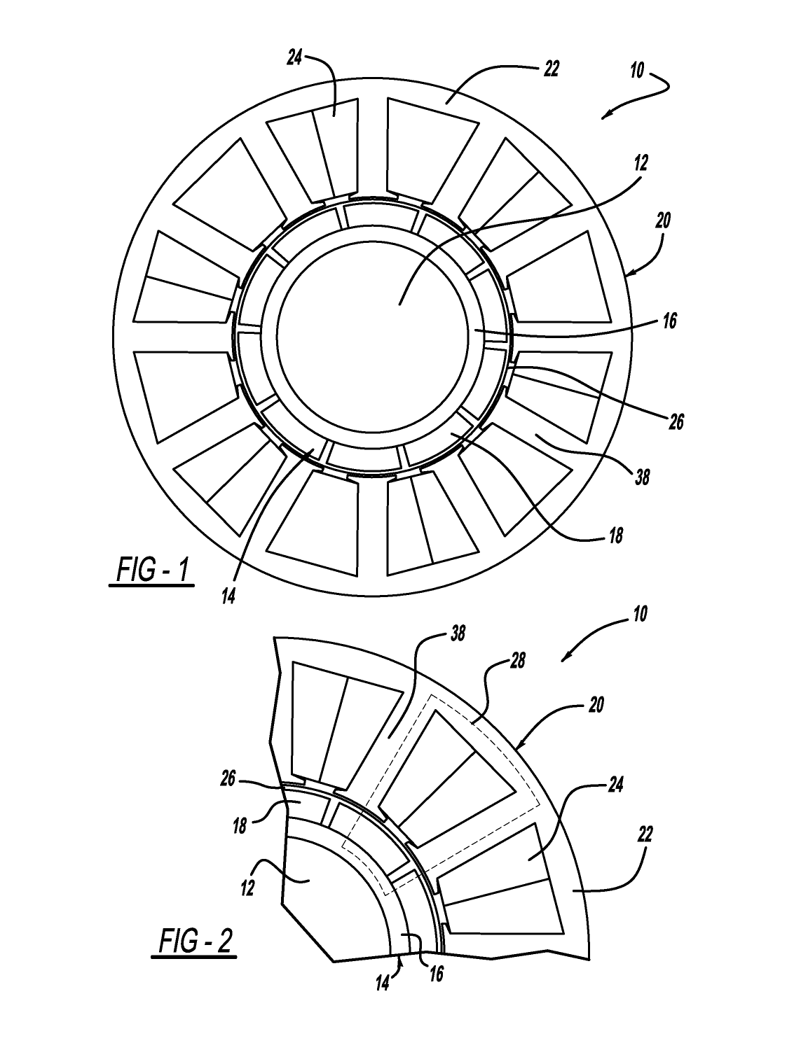

FIG. 1 is a cross-sectional view and FIG. 2 is a quarter section view of a conventional permanent magnet (PM) electric machine 10. The electric machine 10 includes a center shaft 12 surrounded by and mounted to a cylindrical rotor 14. The rotor 14 includes a rotor core 16 on which is mounted a plurality of permanent magnets 18, specifically ten magnets in this non-limiting example. The machine 10 also includes a cylindrical stator 20 including a stator core 22 having spaced apart teeth 38 and a plurality of stator coils 24 positioned between the teeth 38. In this non-limiting example there are twelve stator coils 24. An air gap 26 separates the rotor 14 from the stator 18 and allows it to rotate relative thereto.

As is well understood by those skilled in the art, an alternating current at the proper phase is provided to the stator coils 24 so that the magnetic field generated by the current flowing through the coils 24 interacts with the magnetic field generated by the permanent magnets 18 in a manner that causes the rotor 14 to rotate relative to the stator 20, and thus causes the shaft 12 to rotate performing physical work. FIG. 2 shows a main flux path 28 around one of the coils 24 where the flux path 28 passes through the rotor core 16, the permanent magnet 18, the air gap 26 and the stator 20 to form a closed loop path and link the stator coils 24. The induced voltage of the stator 20 is proportional to the total flux linking the stator coils 24.

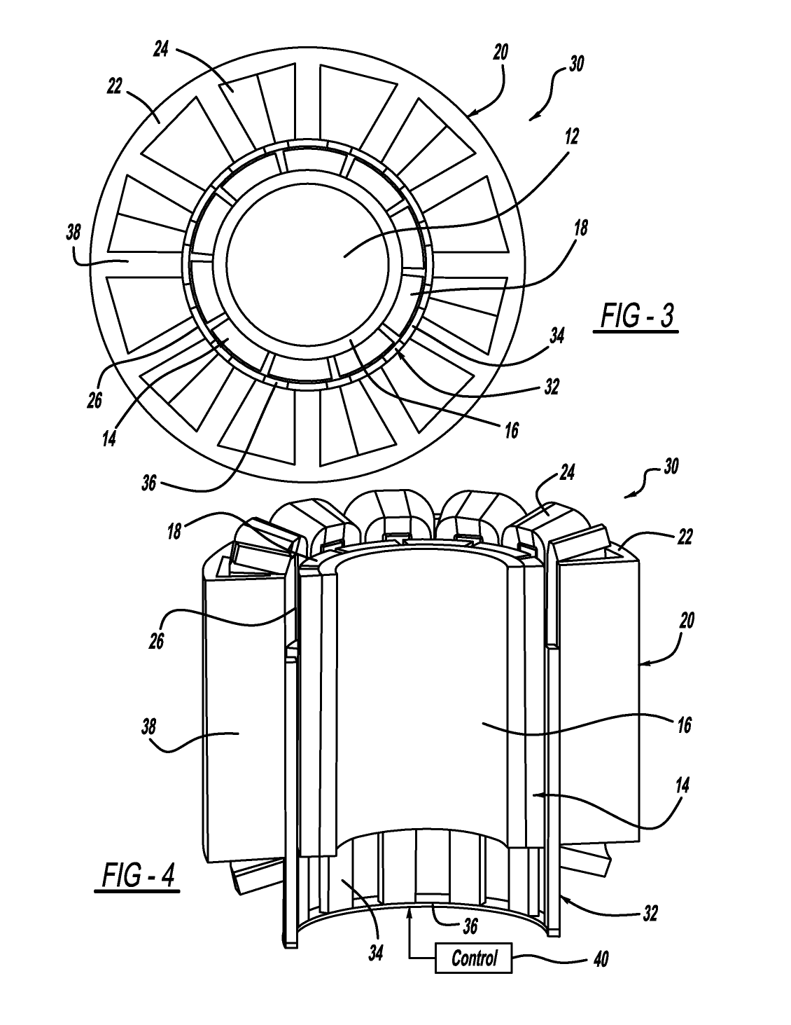

FIG. 3 is a cross-sectional view of a PM electric machine 30 similar to the electric machine 10, where like components are identified by the same reference number. According to the invention, the electric machine 30 includes a controllable magnetic member 32 positioned in the air gap 26 between the rotor 14 and the stator 20, as shown. The magnetic member 32 includes magnetic strip elements 34 mounted to a support hub 36 at one end, where each of the magnetic strip elements 34 is positioned against an end of one of the teeth 38 where the number of strip elements equals the number of teeth 38. In alternate embodiment, the strip elements can be mounted to hubs at both ends. As will be discussed below, the magnetic member 32 is moveable in that it can slide axially relative to the length of the shaft 12 so as to adjust the flux path and flux linkage between the rotor 14 and the stator 20.

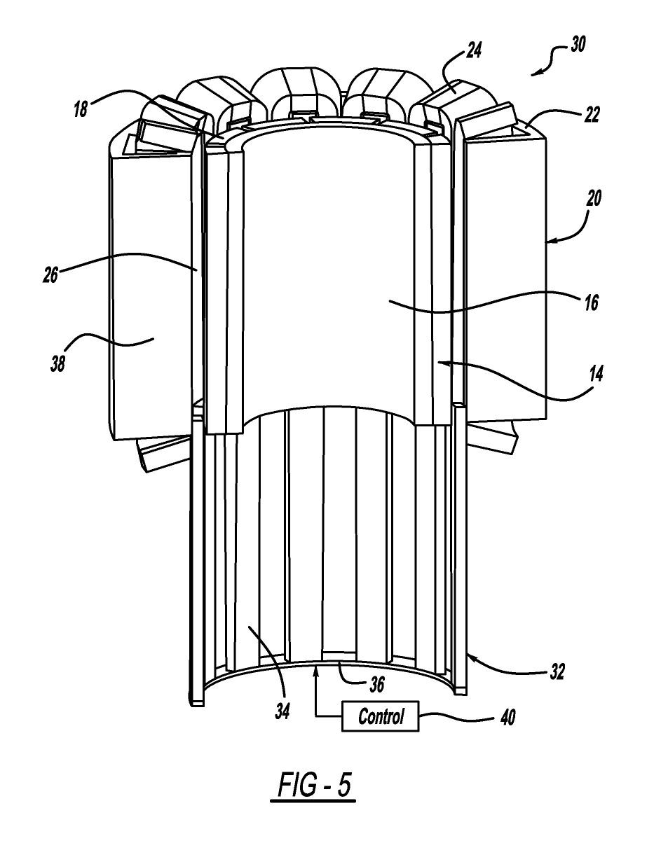

FIG. 4 is a cut-away lengthwise cross-sectional view of the electric machine 30 showing the magnetic member 32 partially inserted within the gap 26 to provide a partial flux link and FIG. 5 is a cross-sectional view of the electric machine 30 with the magnetic member 32 completely withdrawn from the air gap 26. The shaft 12 is not shown for clarity purposes. As is apparent, the magnetic member 32 has a length that is about the same as the active length of the rotor 14 and the stator 20 so that the magnetic member 32 can be positioned completely within the air gap 26 between the rotor 14 and the stator 20. The magnetic strip elements 34 can be made of any suitable magnetic material, such as laminated magnetic steel, a powdered magnetic material or a solid magnetic material. Further, any suitable linear or rotary-to-linear servo-position control device 40 can be used to position the magnetic member 32 the appropriate distance in the air gap 26 consistent with the discussion herein.

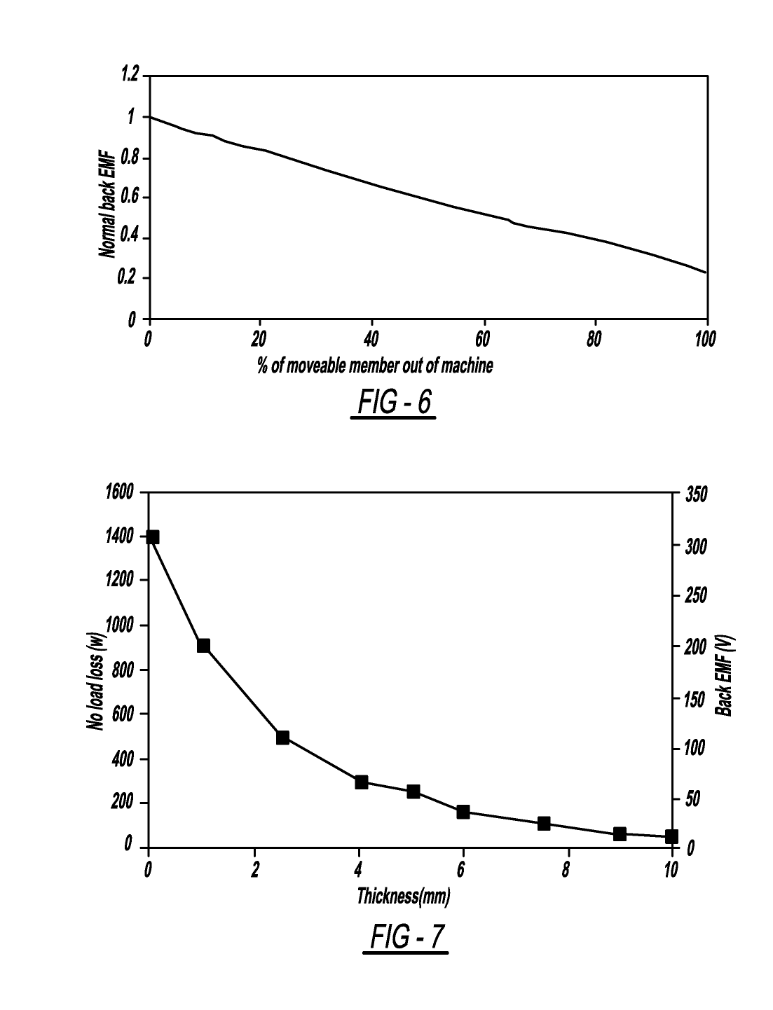

As mentioned above, the magnetic member 32 can be positioned at any location in the air gap 26. Typically, at lower machine speeds and higher machine torques, the magnetic member 32 will be completely inserted within the air gap 26 so that the magnetic member 32 conducts the flux and the flux linkage between the rotor 14 and the stator 20 is strong. As the speed of the machine 30 increases and the magnetic member 32 is withdrawn from the equivalent air gap 26, the air gap 26 gets wider, and thus the flux 28 is reduced and the back EMF created by the magnetic flux 28 is reduced. FIG. 6 is a graph with the percent that the magnetic member 32 is moved out of the machine 30 on the horizontal axis and the normal back EMF on the vertical axis showing the relationship that as the magnetic member 32 is moved out of the machine 30 the back EMF is reduced. Therefore, the speed of the machine 30 can be increased without the drawbacks of the back EMF limiting the machine speed, as discussed above. The axial position of the magnetic number 32 can be a function of the rotor speed, machine torque, system voltage, etc.

The magnetic member 32 also provides a reduced load loss at higher machine speeds over conventional electric machines. Table 1 below shows a conventional PM electric machine on the upper line and a PM electric machine with a magnetic member as discussed above on the lower line. As is apparent, the machine with the magnetic member 32 has a much lower load loss at higher speeds.

TABLE 1

| | | Back EMF | No | No |
|---|---|---|---|---|
| | Torque | (V) | load loss | load loss |
| | (Nm) | @1000 rpm | @1000 rpm(w) | @6000 rpm(w) |
| Normal PM | 175 | 49 | 85 | 1400 |
| Machine | | | | |
| PM machine | 138 | 39 | 70 | 52 |
| with moveable | | | | |
| member* | | | | |

FIG. 7 is a graph showing the thickness in millimeters of the magnetic strip elements 34 on the horizontal axis, load loss in watts on the left vertical axis and back EMF in volts on the right vertical axis showing that as the thickness of the strip elements 34 increases, the load loss decreases, shown by graph line 46, and the back EMF decreases shown by graph line 48.

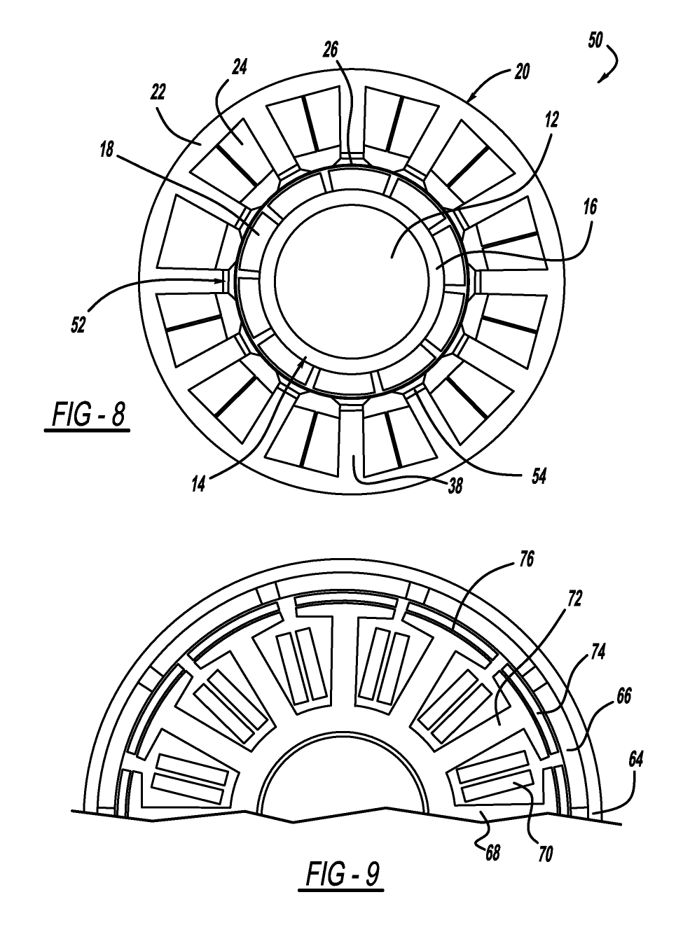

In the machine 30, the magnetic member 32 is positioned in the air gap 26. According to another embodiment, the magnetic member is positioned within the rotor teeth 38. FIG. 8 is a cross-sectional view of an electric machine 50 showing this embodiment where a magnetic member 52 is positioned within the teeth 38 of the stator 20, as shown. The magnetic member 52 includes a plurality of magnetic strip elements 54 that are positioned within suitable openings in the stator teeth 38 and are able to slide axially relative to the length of the machine 50 to control the flux between the rotor 14 and the stator 20 in the manner as discussed above.

The machine 30 discussed above has an inner rotor 14 that rotates inside the stator 24. This is by way of a non-limiting example in that other types of rotor configurations are applicable in the art. FIG. 9 is a partial, cross-sectional view of a permanent magnet electric machine 60 including a shaft 62, an outer rotor 64 including permanent magnets 66, a stator 68 including coils 70 and teeth 72, and a magnetic member 74 including magnetic strip elements 76 as discussed above.

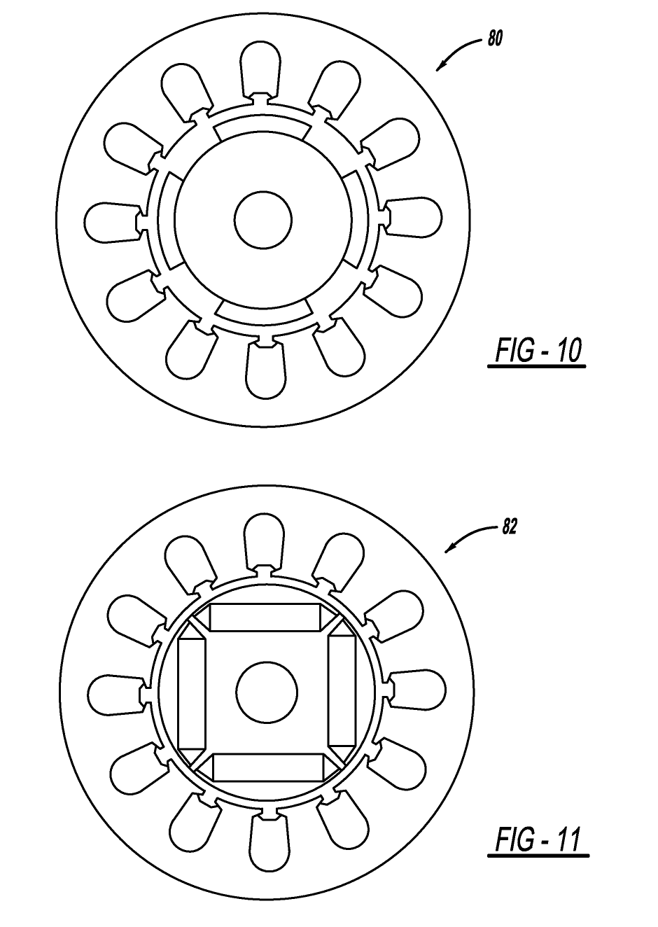

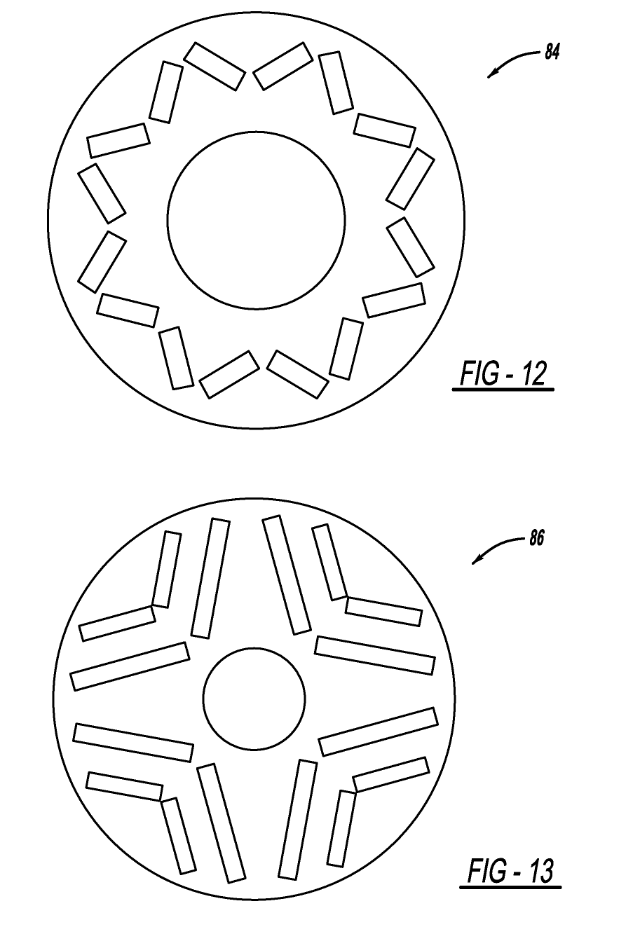

Other variations of a rotor for a permanent magnetic electric machine can also be provided. FIG. 10 is a cross-sectional view of an electric machine 80 including a surface mount rotor, FIG. 11 is a cross-sectional view of a permanent magnet electric machine 82 including an interior rotor, FIG. 12 is a cross-sectional view of a rotor 84 for an electric machine including V-shape permanent magnets and FIG. 13 is a cross-sectional view of a multi-layer permanent magnet stator 86 for a permanent magnet machine. Although the magnetic member is not shown in FIGS. 10-13, it would be positioned in an air gap between the stator and rotor consistent with the discussion herein.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A permanent magnet (PM) electric machine comprising:
a cylindrical stator including a stator core having stator teeth and a stator slot in which electric coils are wound;
a cylindrical rotor including a rotor core having a plurality of spaced apart magnets, said rotor being rotatable relative to the stator and wherein an air gap is defined between the rotor and the stator; and
a controllable magnetic member positioned within or proximate to the air gap, said magnetic member including a plurality of spaced apart magnetic strip elements and being axially moveable relative to the rotor and the stator so that as the speed of the rotor increases the moveable member can be slid out of the machine to reduce the flux linkage between the rotor and the stator and reduce the back EMF of the machine.

2. The electric machine according to claim 1 wherein the magnetic member is positioned within the air gap so that the magnetic strip elements align with and are positioned against the teeth of the stator.

3. The electric machine according to claim 1 wherein the electric strip elements are positioned within the teeth of the stator adjacent to the air gap.

4. The electric machine according to claim 1 wherein the controllable magnetic member includes a non-magnetic hub, said magnetic strip elements being mounted to the hub at one end or mounted to a hub at both ends so that it can move out axially from both ends of the machine.

5. The electric machine according to claim 1 wherein the controllable magnetic member has a length that is substantially the same as the length of the rotor and the stator.

6. The electric machine according to claim 1 wherein the rotor is an inner rotor.

7. The electric machine according to claim 1 wherein the rotor is an outer rotor.

8. The electric machine according to claim 1 wherein the electric machine is a surface mount machine.

9. The electric machine according to claim 1 wherein the electric machine is an interior machine.

10. The electric machine according to claim 1 wherein the electric machine has a V-shape stator.

11. The electric machine according to claim 1 wherein the stator is a multi-layer stator.

12. The electric machine according to claim 1 wherein the rotor magnets are permanent magnets.

13. A permanent magnet (PM) electric machine comprising:
a cylindrical stator including a stator core having stator teeth and a stator slot in which electric coils are wound;
a cylindrical rotor including a rotor core having a plurality of spaced apart permanent magnets, said rotor being rotatable relative to the stator and wherein an air gap is defined between the rotor and the stator; and
a controllable magnetic member positioned in or adjacent to the air gap, said magnetic member including a plurality of spaced apart magnetic strip elements and a non-magnetic hub or hubs to which the magnetic strip elements are mounted, wherein the magnetic strip elements are mounted to the hub at one end or mounted to hubs at both ends, said magnetic member being axially moveable relative to the rotor and the stator so that as the speed of the rotor increases the moveable member can be slid out of the machine to reduce the flux linkage between the rotor and the stator and reduce the back EMF of the machine, wherein the controllable magnetic member has a length that is substantially the same as the length of the rotor and the stator, wherein the controllable magnetic member has a length that is substantially the same as the length of the rotor and the stator.

14. The electric machine according to claim 13 wherein the rotor is an inner rotor.

15. The electric machine according to claim 13 wherein the rotor is an outer rotor.

16. The electric machine according to claim 13 wherein the electric machine is a surface mount machine.

17. The electric machine according to claim 13 wherein the electric machine is an interior machine.

18. The electric machine according to claim 13 wherein the electric machine has a V-shape stator.

19. The electric machine according to claim 13 wherein the stator is a multi-layer stator.

20. The electric machine according to claim 13 wherein the thickness of the magnetic strip elements is the range of 0.2-10 millimeters.
